(19) United States
(12) Patent Application Publication
(10) Pub. No.: US 2017/0171462 A1
(43) Pub. Date: Jun. 15, 2017

(54) Image Collection Method, Information Push Method and Electronic Device, and Mobile Phone

(71) Applicants: Le Holdings (Beijing) Co., Ltd., Beijing (CN); Lemobile Information Technology (Beijing) Co., Ltd, Beijing (CN)

(72) Inventor: Kaiyue Deng, Beijing (CN)

(21) Appl. No.: 15/241,455

(22) Filed: Aug. 19, 2016

Related U.S. Application Data
(63) Continuation of application No. PCT/CN2016/088535, filed on Jul. 5, 2016.

(30) Foreign Application Priority Data
Dec. 15, 2015 (CN) 201510931791.4

(51) Int. Cl. H04N 5/232; G06K 9/00; H04L 29/08; H04N 7/18

(52) U.S. Cl. CPC H04N 5/23219; H04N 7/188; G06K 9/00302; G06K 9/00288; H04L 67/26; H04W 88/02

(57) ABSTRACT

The application provides an imago collection method, an electronic device and a mobile phone. The image collection method is used for a mobile terminal, and a plug-in capable of calling a camera to operate is installed in browser software of the mobile terminal; after an image collection instruction is received, the camera is called to perform image scanning, and whether an image scanned by the camera is a human portrait is judged; if the image is a human portrait, the camera is called to photograph the image; and then an image photographed by the camera is acquired, and the human portrait is saved as a picture and transmitted to a server side.

### CROSS REFERENCE TO RELATED APPLICATIONS

This application is a continuation of international Application No. PCT/CN2016/088535, filed on Jul. 5, 2016, which is based upon and claims priority to Chinese Patent Application No. 201510931791.4, filed on Dec. 15, 2015, titled “Image Collection Method, information Push Method and Device, and Mobile Phone”, the entire contents of which are incorporated herein by reference.

### TECHNICAL FIELD

The application relates to the technical field of communications, and particularly relates to an image collection method, an information push method, an electronic device, and a mobile phone.

### BACKGROUND

Information push is a popular field in recent years. For example, APPs relating to electronic commerce, social websites, etc. may push some information that may attract users to the users according to browsing history, thereby reducing troubles caused by information overload for the users to a certain extent.

However, in the prior arts, information push itself may bring disturbance to the users, which degrades user experience. For some unnecessary APPs, if the disturbance is too frequent, the users may directly delete the APPs. But if no information is pushed to the users, the activity degree of the APPs themselves cannot be increased. Therefore, how to push the information matching current needs of the users to improve the user experience is a problem to be solved.

In addition, when users of mobile terminals need to call cameras to perform operations of photographing, video recording, scanning, etc., the users have to use client software installed in the mobile terminal to call the camera to conduct the operations, but the enablement of multiple pieces of client software also increases loads of software and hardware of the mobile terminal and reduces processing speed.

The application discloses an image collection method, an information push method, an electronic device, and a mobile phone, which can overcome the defects in the prior art that loads of software and hardware of a mobile terminal are high and processing speed is low when a camera is called for operation, and pushed information is hard to match real needs of users and causes poor experience.

One objective of the embodiments of the application is to provide an image collection method, used for a mobile terminal, wherein, a plug-in capable of calling a camera to operate is installed in browser software of the mobile terminal; and the image collection method comprises the following steps: S11. calling the camera to perform image scanning after an image collection instruction is received; S12. judging whether an image scanned by the camera is a human portrait; S13. calling the camera to photograph the image if the image is a human portrait; and S14. acquiring an image photographed by the camera, saving the human portrait as a picture and transmitting the picture to a server side.

The image collection method, wherein, the image collection instruction comes from trigger information generated by clicking a preset button in a browser by a user.

The image collection method, after step S14, further comprising: S15. calling the camera to perform image scanning at a preset time interval, and then returning to step S12.

Another objective of the application is to provide an information push method, used for a server side, comprising the following steps: S21. receiving a human portrait picture; S22. acquiring a user expression attribute corresponding to the picture according to the human portrait picture, and S23. pushing information matching the user expression attribute to a mobile terminal.

The information push method of the application, wherein, the step of acquiring the user expression attribute corresponding to the picture according to the human portrait picture comprises: S221. acquiring a plurality of pieces of user feature information related to the user expression attribute from the human portrait picture; S222. comparing the user feature information with standard feature information corresponding to each expression attribute in a human face database to obtain a matched expression attribute; and S223. using the matched expression attribute as the user expression attribute corresponding to the picture.

The information push method of the application, wherein, the step of pushing the information matching the user expression attribute to the mobile terminal comprises: S231. classifying information according to expression attributes; S232. establishing links between each expression attribute and classified information corresponding thereto; and S233, pushing the classified information corresponding to the links of the user expression attribute to the mobile terminal.

A further objective of the application is to provide an electronic device, comprising: at least one processor; and a memory communicably connected with the at least one processor for storing instructions executable by the at least one processor, wherein execution of the instructions by the at least one processor causes the at least one processor to: call the camera to perform image scanning after an image collection instruction is received; judge whether an image scanned by the camera is a human portrait; call the camera to photograph the image if the image is a human portrait; and acquire an image photographed by the camera, save the human portrait as a picture and transmit the picture to a server side.

Wherein, the image collection instruction comes from trigger information generated by clicking, a preset button in a browser by a user;

Wherein, after acquiring an image photographed by the camera, saving the human portrait as a picture and transmitting the picture to a server side, further comprising: calling the camera to perform image scanning at a preset time interval, and then judging whether an image scanned by the camera is a human portrait.

A further objective of the application is to provide an electronic device, comprising: at least one processor; and a memory communicably connected with the at least one processor for storing instructions executable by the at least one processor, wherein execution of the instructions by the at least one processor causes the at least one processor to: receive a human portrait picture; acquire a user expression attribute corresponding to the picture according to the human portrait picture; and push information matching the user expression attribute to a mobile terminal.

Wherein, the step of acquiring the user expression attribute corresponding to the picture according to the human portrait picture comprises: acquiring a plurality of pieces of user feature information related to the user expression attribute from the human portrait picture; comparing the user feature information with standard feature information corresponding to each expression attribute in a human face database to obtain a matched expression attribute; and using the matched expression attribute as the user expression attribute corresponding to the picture.

Wherein, the step of pushing the in formation matching the user expression attribute to the mobile terminal comprises: classifying information according to expression attributes; establishing links between each expression attribute and classified information corresponding thereto; and pushing the classified information corresponding to the links of the user expression attribute to the mobile terminal.

A further objective of the application is to provide a mobile phone, comprising the above image collection electronic device.

A further objective of the application is to provide a non-transitory computer-readable storage medium storing executable instructions that, when executed by an electronic device, cause the electronic device to: call the camera to perform image scanning after an image collection instruction is received; judge whether an image scanned by the camera is a human portrait; call the camera to photograph the image if the image is a human portrait; and acquire an image photographed by the camera, save the human portrait as a picture and transmit the picture to a server side.

Wherein, the image collection instruction comes from trigger information generated by clicking a preset button in a browser by a user;

Wherein, after acquiring an image photographed by the camera, saving the human portrait as a picture and transmitting the picture to a server side, further comprising: calling the camera to perform image scanning at a preset time interval, and then judging, whether an image scanned by the camera is a human portrait.

A further objective of the application is to provide a non-transitory computer-readable storage medium storing executable instructions that, when executed by an electronic device, cause the electronic device to: receive a human portrait picture; acquire a user expression attribute corresponding to the picture according to the human portrait picture; and push information matching the user expression attribute to a mobile terminal.

Wherein, the step of acquiring the user expression attribute corresponding to the picture according to the human portrait picture comprises: acquiring a plurality of pieces of user feature information related to the user expression attribute from the human portrait picture; comparing the user feature information with standard feature information corresponding to each expression attribute in a human face database to obtain a matched expression attribute; and using the matched expression attribute as the user expression attribute corresponding to the picture.

Wherein, the step of pushing the information matching the user expression attribute to the mobile terminal comprises: classifying information according to expression attributes; establishing links between each expression attribute and classified information corresponding thereto; and pushing the classified information corresponding to the links of the user expression attribute to the mobile terminal.

The technical solution of the embodiments of the application has the following advantages:

The embodiments of the application provide an image collection method, an information push method and an electronic device used for a mobile terminal, and a plug-in capable of calling a camera to operate is installed in browser software of the mobile terminal; after an image collection instruction is received, the camera is called to perform image scanning, and whether an image scanned by the camera is a human portrait is judged; if the image is a human portrait, the camera is called to photograph the image; and then an image photographed by the camera is acquired, and the human portrait is saved as a picture and transmitted to a server side. There is no need to install special video processing client software to call the camera to perform operations of scanning, photographing, video recording, etc., and the camera is called to perform corresponding operations just through the browser software of the mobile terminal in response to the image collection instruction of the user, so that the amount of client software installed in the mobile terminal is reduced, loads of software and hardware of the mobile terminal are decreased and response speed is increased. Moreover, the camera is called to photograph the image and the human portrait is saved as a picture and transmitted to a server side only when it is judged that the image scanned by the camera is a human portrait, thereby preventing frequent thread calls and excessive memory usage of the mobile terminal and being beneficial to increase of the response speed.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a specific example of a preset button in an image collection method in embodiment 1 of the application;

FIG. 2 is a flow chart of a specific example of the image collection method in embodiment 1 of the application;

FIG. 3 is a flow chart of a specific example of an information push method in embodiment 2 of the application;

FIG. 4 is a flow chart of a specific example of acquiring a user expression attribute according to a human portrait picture in the information push method in embodiment 2 of the application;

FIG. 5 is a flow chart of a specific example of pushing information matching the user expression attribute to the mobile terminal in the information push method in embodiment 2 of the application;

FIG. 6 is a structural diagram of an image collection device in embodiment 3 of the application;

FIG. 7 is a structural diagram of an information push device in embodiment 4 of the application;

FIG. 8 is a schematic diagram of hardware configuration of an image collection electronic device in embodiment 8 of the application.

FIG. 9 is a schematic diagram of hardware configuration of an information push electronic device in embodiment 9 of the application.

### REFERENCE SIGNS

a—menu item button; 11—scanning unit; 12—human portrait identifying unit; 13—photographing unit; 14—transmitting unit; 15—updating unit; 21—receiving unit; 22—expression attribute acquiring unit; 23—information pushing unit; 221—user feature information acquiring subunit; 222—comparing subunit; 223—expression attribute determining subunit; 231—classifying subunit; 232—linking subunit; and 233—pushing subunit.

### DETAILED DESCRIPTION

In order to clearly describe objectives, the technical solutions and advantages of the application. A clear and complete description of the technical solutions in the application will be given below, in conjunction with the accompanying drawings in the embodiments of the application. Apparently, the embodiments described below are a part, but not all, of the embodiments of the application.

### Embodiment 1

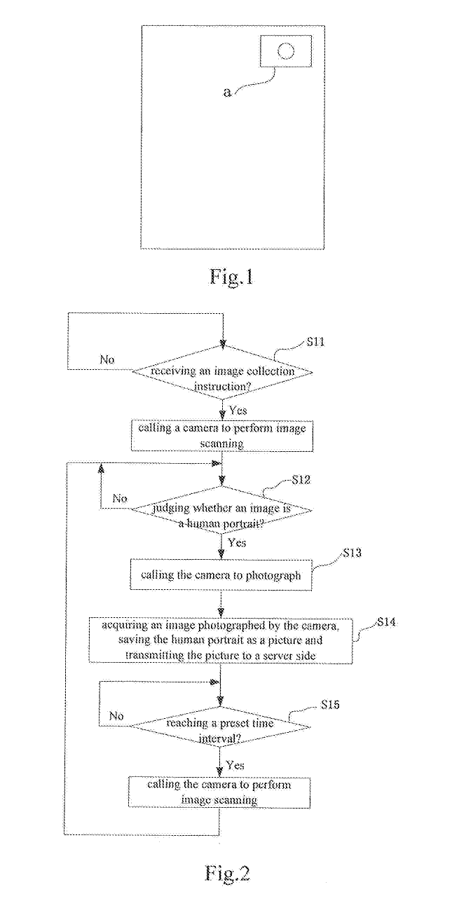

The embodiment of the application provides an, image collection method used for a mobile terminal, and a plug-in capable of calling a camera to operate is installed in browser software of the mobile terminal. Specifically, the mobile terminal includes but not limited to a mobile phone, a personal digital assistant (PDA), a handheld computer or a tablet personal computer and the like. Browser software which supports html5 can be installed in the mobile terminal, and a plug-in capable of calling a camera to perform operations of scanning, photographing, etc., such as a scanning plug-in, a photographing plug-in, etc., is installed in the browser software. After the plug-in is installed, a menu item button capable of triggering the above plug-in can be arranged on a browser as an interface for triggering the above plug-in. The user can see the menu item button capable of triggering the above operation on a browsing interface while opening the browser to browse. The above menu item button can be marked with characters, and can also be marked with a small image so as to be more vivid. As shown in FIG. 1, a small camera can be used for marking the menu item button a capable of triggering the scanning plug-in. When viewing information through the browser, the user clicks the above menu item button displayed on the browser to call the camera to operate, which is very convenient.

As shown in FIG. 2, the image collection method comprises the following steps:

In S11, the camera is called to perform image scanning after receiving an image collection instruction; wherein, preferably, the image collection instruction comes from trigger information generated by clicking a preset button in a browser by a user; generally; the menu item button capable of triggering the scanning plug-in is used as the preset button, and the camera can be called to perform image scanning when trigger information generated by clicking the preset button is received; specifically, if the mobile terminal comprises a plurality of cameras, a preset camera can be preferably called or a corresponding camera is called according to user selection; for example, some mobile phones comprise a front-facing camera and a rear-facing camera, and in general, the front-facing camera is preferably called to perform image scanning, in this way, in a process that the user views a web page with the browser, the front-facing camera can be called to perform image scanning on the face of the user by just clicking the preset button displayed on the browser without interrupting the browsing process of the user, thereby bringing better experience;

In S12. whether an image scanned by the camera is a human portrait or not is judged; wherein, specifically, in the process of image scanning, it can be determined whether tire image scanned by the camera and temporarily stored in a local cache of the mobile terminal is a human portrait through a facial recognition algorithm locally stored in the mobile terminal;

In S13, the camera is called to photograph the image if the image is a human portrait; wherein, specifically, the camera can be automatically called by an internal thread to photograph the image after it is determined that the image is a human portrait and no additional operation of the user is required; and

In S14, an image photographed by the camera is acquired, and saving the human portrait as a picture and transmitting the picture to a server side;

Wherein, in the image collection method in the embodiment, there is no need to install special video processing client software to call the camera to perform operations of scanning, photographing, video recording, etc., and the camera is called to perform corresponding operations just through the browser software of the mobile terminal in response to the image collection instruction of the user, so that the amount of the client software installed in the mobile terminal is reduced, loads of software and hardware of the mobile terminal are decreased, and response speed is increased; moreover, the camera is called to photograph the image and the human portrait is saved as a picture and transmitted to a server side only when it is judged that the image scanned by the camera is a human portrait, thereby preventing frequent thread calls and excessive memory usage of the mobile terminal and being beneficial to increase of the response speed; and

Preferably, in S15. the camera is called to perform image scanning at a preset time interval, and then returning to step S12;

Wherein, specifically, the camera is called to perform image scanning at a preset time interval, for example, every 30 seconds, from a time when the human portrait picture is transmitted to a server for the first time; the camera is called to photograph the image after it is judged that the image scanned by the camera is a human portrait, and the newly acquired human portrait is saved as a picture and transmitted to the server side; and the server side is enabled to acquire an updated human portrait in time and then conduct analysis accordingly to obtain a latest user expression attribute so as to adjust and update information pushed to the user in time, thus, data support is provided for the server side to push the information matching current user needs.

### Embodiment 2

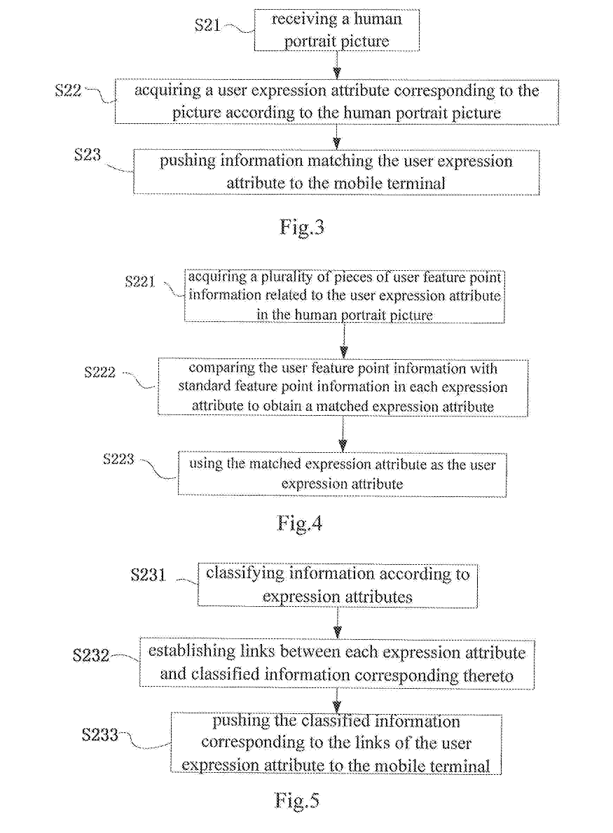

The embodiment of the application provides an information push method used for a server side. The server side may be a cloud server which has high computing speed and is capable of responding to the user needs in time. As shown in FIG. 3, the information push method in the embodiment comprises the following, steps:

In S21. a human portrait picture is received; and

In S22. a user expression attribute corresponding to the picture is acquired according to the human portrait picture; wherein, specifically, user expression attributes can be classified into five types as happy, angry, sad, serene and surprise, which can reflect the current mood of the user;

Wherein, preferably, as shown in FIG. 4, step S22 comprises:

In S221. a plurality of pieces of user feature information related to the user expression attribute in the human portrait picture is acquired; wherein, specifically, after receiving the human portrait picture transmitted by the mobile terminal, the server side acquires a plurality of pieces of user feature information related to the user expression attribute in the human portrait picture, such as feature information of the brows, eyes, nose, mouth, etc. in corresponding positions of the face, by means of a face++ facial recognition algorithm, and the current facial expression of the user can be comprehensively expressed through the above user feature information, thereby establishing a foundation for later analysis and acquisition of an accurate user expression attribute;

In S222, the user feature information with standard feature information corresponding to each expression attribute in a human face database is compared to obtain a matched expression attribute; and

In S223, the matched expression attribute is used as the user expression attribute corresponding to the picture;

Wherein, preferably, an expression attribute with the largest number of pieces of standard feature information coincident with or similar to the user feature information in all the expression attributes is used as the matched expression attribute; specifically, the user feature information is compared with standard feature information corresponding to each expression attribute in the human face database to obtain the number of pieces of standard feature information coincident with or similar to the user feature information in each expression attribute; the larger the number is, the similar the user expression attribute and the expression attribute in the human face database are; for example, if the number of pieces of standard feature information coincident with or similar to the user feature information in the expression attribute of sad is largest, the user expression attribute can be judged to be sad; by determining an expression attribute with the largest number of pieces of standard feature information coincident with or similar to the user feature information in all the expression attributes as the matched expression attribute, and using the matched expression attribute as the user expression, attribute corresponding to the picture, the user expression attributes can be accurately classified; and

In S23, information matching the user expression attribute to the mobile terminal is pushed; wherein, specifically, for example, if the user expression attribute is judged to be sad, some information capable of alleviating the sad mood of the user can be pushed to the user, so as to match the current user needs as much as possible;

Wherein, preferably, as shown in FIG. 5, step S23 comprises:

In S231. information is classified according to expression attributes; wherein, specifically, for example, when the expression attributes are classified into five types as happy, angry, sad, serene and surprise, the information is classified according to the five types of expression attributes, i.e., classified into information suitable for push when the expression attribute is happy, information suitable for push when the expression attribute is angry, information suitable for push when the expression attribute is sad, information suitable for push when the expression attribute is serene, information suitable for push when the expression attribute is surprise, etc.; and of course, the classification of information can be adaptively adjusted according to the practical push effect so as to better conform to the user needs;

In S232. links between each expression attribute and classified information corresponding thereto are established: wherein, specifically, each expression attribute can correspond to different labels (IDs); the classified information is respectively linked to the labels (IDs) corresponding to the expression attribute, so as to establish the links between each expression attribute and the classified information corresponding thereto; and

In S233. the classified information corresponding to the links of the user expression attribute to the mobile terminal is pushed, wherein the information matching the user needs can be pushed to the user.

In the information push method in the embodiment, after the human portrait picture is received, the user expression attribute is acquired according to the human portrait picture; and the information matching the user expression attribute is pushed to the mobile terminal. The information matching the expression attribute of the user can be pushed to the user according to the current expression attribute of the user so as to match a current mood of the user and conform to real user needs, thereby promoting the attention of the user to the pushed information and reaching a good push effect.

### Embodiment 3

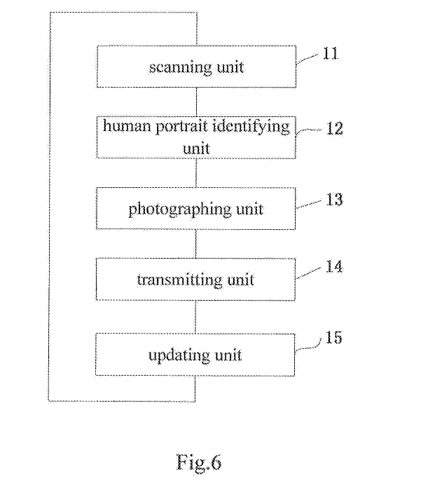

The embodiment of the application further provides an image collection device, used for a mobile terminal, wherein, a plug-in capable of calling a camera to operate is installed in browser software of the mobile terminal; and referring to FIG. 6, the image collection device of this embodiment comprises: a scanning unit 11 that calls the camera to perform image scanning after an image collection instruction is received; preferably, the instruction for image collection received by the scanning unit 11 is a triggering information generated by a user clicking on a preset bottom in a browser; a human portrait recognizing unit 12, for judging whether an image scanned by the camera is a human portrait; preferably, a photographing unit 13 that calls the camera to photograph the image if the image is a human portrait; and a transmitting unit 14 that acquires an image photographed by the camera, saving the human portrait as a picture and transmitting the picture to a server side.

For the image collection device of this embodiment, there is no need to install special video processing client software to call the camera to perform operations of scanning, photographing, video recording, etc., and the camera is called to perform corresponding operations just through the browser software of the mobile terminal in response to the image collection instruction of the user, so that the amount of client software installed in the mobile terminal is reduced, loads of software and hardware of the mobile terminal are decreased and response speed is increased. Moreover, the camera is called to photograph the image and the human portrait is saved as a picture and transmitted to a server side only when it is judged that the image scanned by the camera is a human portrait, thereby preventing frequent thread calls and excessive memory usage of the mobile terminal and being beneficial to increase of the response speed.

Preferably, the image collection device also provides an updating unit 15 that actuates the scanning unit 11 at a preset time interval to call the camera to scan an image, before actuating the human portrait recognizing unit 12.

The image collection device of this embodiment may allow the server to acquire an updated human portrait in time, based on which the updated expression attributes of user can be analyzed, so as to adjust and update the information pushed to the users, thereby providing date support to the server pushing information that meet the users' requirements.

### Embodiment 4

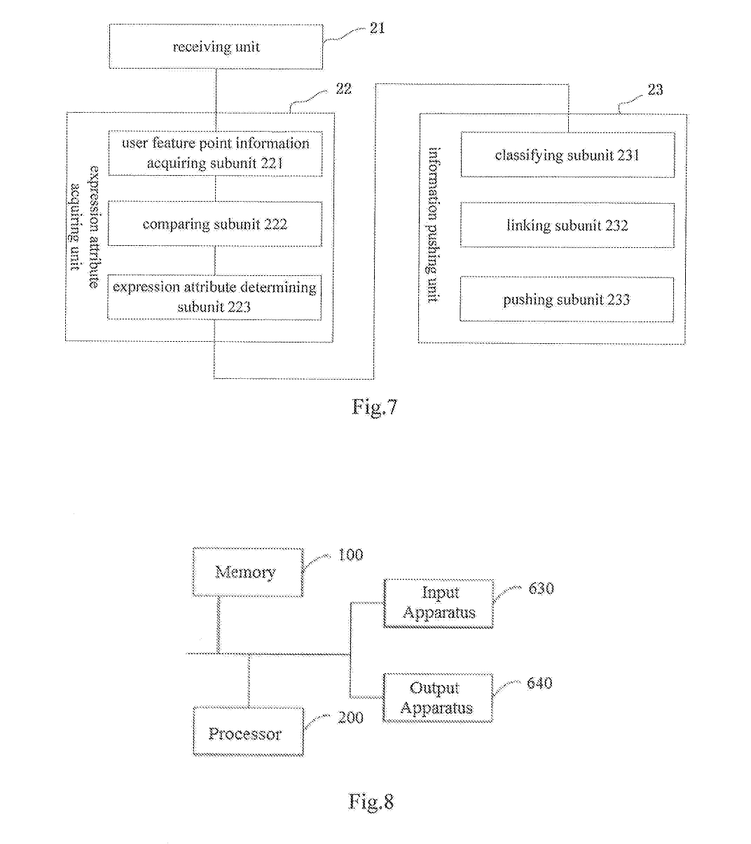

This embodiment of the application provides an information push device, used for a server side, as shown in FIG. 7, comprising: a receiving unit 21 that receives a human portrait picture; a expression attribute acquiring unit 22 that acquires a user expression attribute corresponding to the picture according to the human portrait picture; and an information pushing unit 23 that pushes information matching the user expression attribute to a mobile terminal.

Preferably, the expression attribute acquiring unit 22 comprises: a user feature information acquiring subunit 221 that acquires a plurality of pieces of user feature information related to the user expression attribute from the human portrait picture; a comparing subunit 222 that compares the user feature information with standard feature information corresponding to each expression attribute in a human face database to obtain a matched expression attribute; and an expression attribute determining subunit (223) that uses the matched expression attribute as the user expression attribute corresponding to the picture.

Preferably, the information push unit 23 includes a sorting subunit 231 that sorts the information according to expression attributes; a linking subunit 232 that builds a link between each expression attribute and corresponding sorted information; a push subunit 233 pushes the sorted information corresponding to the link of user's expression attribute to the mobile terminal.

For the information push device of this embodiment, after the human portrait picture is received, the user expression attribute is acquired according to the human portrait picture; and the information matching the user expression attribute is pushed to the mobile terminal. The information matching the expression attribute of the user can he pushed to the user according to the current expression attribute of the user so as to match a current mood of the user and conform to real user needs, thereby promoting the attention of the user to the pushed information and reaching a good push effect.

### Embodiment 5

The embodiment of the application provides a mobile phone, including the image collection electronic device of embodiment 3. There is no need to install special video processing client software to call a camera to perform operations of scanning, photographing, video recording, etc., and the camera is called to perform corresponding operations just through browser software of the mobile terminal in response to an image collection instruction of a user, so that the amount of client software installed in the mobile terminal is reduced, loads of software and hardware of the mobile terminal are decreased, and response speed is increased. Moreover, the camera is called to photograph an image and a human portrait is saved as a picture and transmitted to a server side only when it is judged that the image scanned by the camera is a human portrait, thereby preventing frequent thread calls and excessive memory usage of the mobile terminal and being beneficial to increase of the response speed.

### Embodiment 6

The embodiment of the application provides a non-transitory computer-readable storage medium storing executable instructions that, when executed by an electronic device, cause the electronic device to; call the camera to perform image scanning after an image collection instruction is received; judge whether an image scanned by the camera is a human portrait; call the camera to photograph the image if the image is a human portrait; and acquire an image photographed by the camera, save the human portrait as a picture and transmit the picture to a server side.

As a preferred embodiment, the image collection instruction conies from trigger information generated by clicking a preset button in a browser by a user.

As a preferred embodiment, after acquiring, an image photographed by the camera, saving the human portrait as a picture and transmitting the picture to a server side, further comprising: calling the camera to perform image scanning at a preset time interval, and then judging whether an image scanned by the camera is a human portrait.

### Embodiment 7

The embodiment of the application provides a non-transitory computer-readable storage medium storing executable instructions that, when executed by an electronic device, cause the electronic device to: receive a human portrait picture; acquire a user expression attribute corresponding to the picture according to the human portrait picture; and push information matching the user expression attribute to a mobile terminal.

As a preferred embodiment, for the non-transitory computer-readable storage medium, the step of acquiring the user expression attribute corresponding to the picture according to the human portrait picture comprises: acquiring a plurality of pieces of user feature information related to the user expression attribute from the human portrait picture; comparing the user feature information with standard feature information corresponding to each expression attribute in a human face database to obtain a matched expression attribute; and using the matched expression attribute as the user expression attribute corresponding to the picture.

As a preferred embodiment, the step of pushing the information matching the user expression attribute to the mobile terminal comprises: classifying information according to expression attributes; establishing links between each expression attribute and classified information corresponding thereto; and pushing the classified information corresponding to the links of the user expression attribute to the mobile terminal.

### Embodiment 8

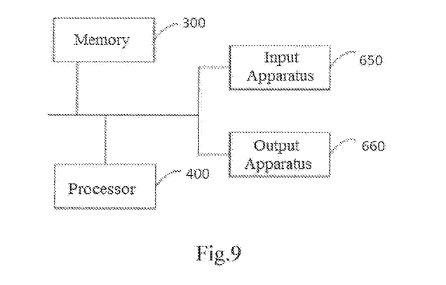

FIG. 8 is a schematic diagram of the hardware configuration of the electronic device provided by the embodiment, which performs the image collection method. As shown in FIG. 8, the device includes: one or more processors 200 and a memory 100, wherein one processor 200 is shown in FIG. 8 as an example. The device that performs the image collection method further includes an input apparatus 630 and an output apparatus 640.

The processor 200, the memory 100, the input apparatus 630 and the output apparatus 640 may be connected via a bus line or other means, wherein connection via a bus line is shown in FIG. 8 as an example.

The memory 100 is a non-transitory computer-readable storage medium that can be used to store non-transitory software programs, non-transitory computer-executable programs and modules, such as the program instructions/modules corresponding to the image collection method of the embodiments of the application (e.g. scanning unit 11; human portrait identifying unit 12; photographing unit 13; transmitting unit 14; updating unit 15 shown in the FIG. 6). The processor 200 executes the non-transitory software programs, instructions and modules stored in the memory 100 so as to perform various function application and data processing of the server, thereby implementing the image collection method of the above-mentioned method embodiments.

The memory 100 includes a program storage area and a data storage area, wherein, the program storage area can store an operation system and application programs required for at least one function; the data storage area ran store data generated by use of the image collection device. Furthermore, the memory 100 may include a high-speed random access memory, and may also include a non-volatile memory, e.g. at least one magnetic disk memory unit, flash memory unit, or other non-volatile solid-state memory unit. In some embodiments, optionally, the memory 100 includes a remote memory accessed by the processor 200, and the remote memory is connected to the image collection device via network connection. Examples of the aforementioned network include but not limited to Internet, intranet, LAN, GSM, and their combinations.

The input apparatus 630 receives digit or character information, so as to generate signal input related to the user configuration and function control of the image collection device. The output apparatus 640 includes display devices such as a display screen.

The one or more modules are stored in the memory 100 and, when executed by the one or more processors 200, perform the image collection method of any one of the above-mentioned method embodiments.

The above-mentioned product can perform the method provided by the embodiments of the application and have function modules as well as beneficial effects corresponding to the method. Those technical details not described in this embodiment can be known by referring to the method provided by the embodiments of the application.

### Embodiment 9

FIG. 9 is a schematic diagram of the hardware configuration of the electronic device provided by the embodiment of the application, which performs the information push method. As shown in FIG. 9, the device includes: one or more processors 400 and a memory 300, wherein one processor 400 is shown in FIG. 9 as an example. The device that performs the information push method further includes an input apparatus 650 and an output apparatus 660.

The processor 400, the memory 300, the input apparatus 650 and the output apparatus 660 may be connected via a bus line or other means, wherein connection via a bus line is shown in FIG. 9 as an example.

The memory 300 is a non-transitory computer-readable storage medium that can be used to store non-transitory software programs, non-transitory computer-executable programs and modules, such as the program instructions/modules corresponding to the information push method of the embodiments of the application (e.g. receiving unit 21; expression attribute acquiring unit 22; information pushing unit 23 shown in the FIG. 7). The processor 400 executes the non-transitory software programs, instructions and modules stored in the memory 300 so as to perform various function application and data processing of the server, thereby implementing the information push method of the above-mentioned method embodiments.

The memory 300 includes a program storage area and a data storage area, wherein, the program storage area can store an operation system and application programs required for at least one function; the data storage area can store data generated by use of the information push device. Furthermore, the memory 300 may include a high-speed random access memory, and may also include a non-volatile memory, e.g. at least one magnetic disk memory unit, flash memory unit, or other non-volatile solid-state memory unit. In some embodiments, optionally, the memory 300 includes a remote memory accessed by the processor 400, and the remote memory is connected to the information push device via network connection. Examples of the aforementioned network include but not limited to Internet, intranet, LAN, GSM, and their combinations.

The input apparatus 650 receives digit or character information, so as to generate signal input related to the user configuration and function control of the information push device. The output apparatus 660 includes display devices such as a display screen.

The one or more modules are stored in the memory 300 and, when executed by the one or more processors 400, perform the information push method of any one of the above-mentioned method embodiments.

The above-mentioned product can perform the method provided by the embodiments of the application and have function modules as well as beneficial effects corresponding to the method. Those technical details not described in this embodiment can be known by referring to the method provided by the embodiments of the application.

The electronic device of the embodiments of the application can exist in many roans, including but not limited to:

(1) Mobile communication devices: The characteristic of this type of device is having a mobile communication function with a main goal of enabling voice and data communication. This type of terminal device includes: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device includes: PDA, MID, UMPC devices, such as iPad.

(3) Portable entertainment devices: This type of device is able to display and play multimedia contents. This type of terminal device includes: audio and video players (such as iPod), handheld game players, electronic books, intelligent toys, and portable GPS devices.

(4) Servers: devices providing computing service. The structure of a server includes a processor a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The above-mentioned device embodiments are only illustrative, wherein the units described as separate parts may be or may not he physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the application, without restricting the technical scheme of the application. Although detailed description of the application is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the application.

What is claimed is:

1. An image collection method, used for a mobile terminal, wherein:
a plug-in capable of calling a camera to operate is installed in browser software of the mobile terminal; and
the image collection method comprises the following steps:
S11. calling the camera to perform image scanning after an image collection instruction is received;
S12. judging whether an image scanned by the camera is a human portrait;
S13. calling the camera to photograph the image if the image is a human portrait; and
S14. acquiring an image photographed by the camera, saving the human portrait as a picture and transmitting the picture to a server side.

2. The image collection method of claim 1, wherein, the image collection instruction comes from trigger information generated by clicking a preset button in a browser by a user.

3. The image collection method of claim 1, wherein, after step S14, further comprising:
S15. calling the camera to perform image scanning at a preset time interval, and then returning to step S12.

4. An information push method, used for a server side, wherein, comprising the following steps:
S21. receiving a human portrait picture;
S22. acquiring a user expression attribute corresponding to the picture according to the human, portrait picture; and
S23. pushing information matching the user expression attribute to a mobile terminal.

5. The information push method of claim 4, wherein, the step of acquiring the user expression attribute corresponding to the picture according to the human portrait picture comprises:
S221. acquiring a plurality of pieces of user feature information related to the user expression attribute from the human portrait picture;
S222. comparing the user feature information with standard feature information corresponding to each expression attribute in a human face database to obtain a matched expression attribute; and
S223. using the matched expression attribute as the user expression attribute corresponding to the picture.

6. The information push method of claim 4, wherein, the step of pushing the information matching the user expression attribute to the mobile terminal comprises:
S231. classifying information according to expression attributes;
S232. establishing links between each expression attribute and classified information corresponding thereto; and
S233. pushing the classified information corresponding to the links of the user expression attribute to the mobile terminal.

7. An electronic device, used for a mobile terminal, comprising:
at least one processor; and a memory communicably connected with the at least one processor for storing instructions executable by the at least one processor, wherein execution of the instructions by the at least one processor causes the at least one processor to:
call the camera to perform image scanning after an image collection instruction is received;
judge whether an image scanned by the camera is a human portrait;
call the camera to photograph the image if the image is a human portrait; and
acquire an image photographed by the camera, save the human portrait as a picture and transmit the picture to a server side.

8. The electronic device of claim 7, wherein, the image collection instruction comes from trigger information generated by clicking a preset button in a browser by a user.

9. The electronic device of claim 7, wherein, after acquiring an image photographed by the camera, saving the human portrait as a picture and transmitting the picture to a server side, further comprising:
calling the camera to perform image scanning at a preset time interval, and then judging whether an image scanned by the camera is a human portrait.

10. An electronic device, used for a server side, comprising:
at least one processor; and a memory communicably connected with the at least one processor for storing instructions executable by the at least one processor, wherein execution of the instructions by the at least one processor causes the at least one processor to
receive a human portrait picture;
acquire a user expression attribute corresponding to the picture according, to the human portrait picture; and
push information matching the user expression attribute to a mobile terminal.

11. The electronic device of claim 10, wherein, the step of acquiring the user expression attribute corresponding to the picture according to the human portrait picture comprises:
acquiring a plurality of pieces of user feature information related to the user expression attribute from the human portrait picture;
comparing the user feature information with standard feature information corresponding to each expression attribute in a human face database to obtain a matched expression attribute; and
using the matched expression attribute as the user expression attribute corresponding to the picture.

12. The electronic device of claim 11, wherein, the step of pushing the information matching the user expression attribute to the mobile terminal, comprises:
classifying information according to expression attributes;
establishing links between each expression attribute and classified information corresponding thereto; and
pushing, the classified information corresponding to the links of the user expression attribute to the mobile terminal.

13. A non-transitory computer-readable storage medium storing executable instructions that, when executed by an electronic device, cause the electronic device to:
call the camera to perform image scanning after an image collection instruction is received;
judge whether an image scanned by the camera is a human portrait;
call the camera to photograph the image if the image is a human portrait; and
acquire an image photographed by the camera, save the human portrait as a picture and transmit the picture to a server side.

14. The non-transitory computer-readable storage medium of claim 13, wherein, the image collection instruction comes from trigger information generated by clicking a preset button in a browser by a user.

15. The non-transitory computer-readable storage medium of claim 13, wherein, after acquiring an image photographed by the camera, saving the human portrait as a picture and transmitting the picture to a server side, further comprising:
calling the camera to perform image scanning at a preset time interval, and then returning to step S12.

46. A non-transitory computer-readable storage medium storing executable instructions that, when executed by an electronic device, cause the electronic device to:
receive a human portrait picture;
acquire a user expression attribute corresponding to the picture according to the human portrait picture; and
push information matching the user expression attribute to a mobile terminal.

17. The non-transitory computer-readable storage medium of claim 16, wherein, the step of acquiring the user expression attribute corresponding to the picture according to the human portrait picture comprises:
acquiring a plurality of pieces of user feature information related to the user expression attribute from the human portrait picture;
comparing the user feature information with standard feature information corresponding to each expression attribute in a human face database to obtain a matched expression attribute; and
using the matched expression attribute as the user expression attribute corresponding to the picture.

18. The non-transitory computer-readable storage medium of claim 16, wherein, the step of pushing the information matching the user expression attribute to the mobile terminal comprises:
classifying information according to expression attributes;
establishing links between each expression attribute and classified information corresponding thereto; and
pushing the classified information corresponding to the links of the user expression attribute to the mobile terminal.
